(19) United States
(12) Patent Application Publication
(10) Pub. No.: US 2021/0352850 A1
(43) Pub. Date: Nov. 18, 2021

(54) Automatically Rotating Plant Pot

(71) Applicant: Karissa En-Ling Tang, Milpitas, CA (US)

(72) Inventor: Karissa En-Ling Tang, Milpitas, CA (US)

(21) Appl. No.: 16/876,862

(22) Filed: May 18, 2020

(51) Int. Cl. A01G 9/02

(52) U.S. Cl. CPC A01G 9/021

(57) ABSTRACT

This invention automatically rotates the plant pot so that all sides of the plant get even sunlight over the course of a day or week, without any manual intervention. This helps the plant grow more straight rather than bend on one side towards the sun.

### FIELD OF THE INVENTION

This invention helps ensure that all sides of a plant get even and adequate sun exposure to reduce the chance that the plant grows towards one side.

### BACKGROUND OF THE INVENTION

Plants often get uneven sun exposure. For indoor plants, the side that faces the window may get reasonable sunlight; however, the opposite side gets limited sun exposure. The same is true for outdoor plants, where physical structures and trees prevent all sides of the plant from receiving even sunlight. This unbalanced sunlight often causes the plant to grow crooked, usually towards the direction of the side with the most sunlight, rather than straight and upright.

To address this problem, some individuals manually swivel the plant pot. However, this is tedious and difficult to do on a regular basis.

By automatically rotating the plant pot on a regular, pre-set schedule, this invention helps ensure that all sides of the plant get even sunlight over the course of a day or week, without any manual intervention. This helps the plant grow straight up rather than bend to one side.

### SUMMARY OF THE INVENTION

The present invention comprises a flower pot with a mechanism that allows the pot to automatically rotate based on a preset rotational speed. This allows the plant pot to rotate so that all sides of the plant can get equal exposure to the sun's rays within the course of the day or week.

A motor situated within the base of the structure turns a disc that sits on top of the base structure. The disc contains four grooves. The plant pot sits on top of the disc and can be detached from the base structure. The legs of the plant pot are inserted into the grooves of the disc so that when the disc rotates, the plant pot can securely rotate with the disc.

### BRIEF DESCRIPTION OF THE DRAWINGS

FIG. 1. Plant pot with four legs.

FIG. 2. View from the bottom of the plant pot with four legs.

FIG. 3. Base structure with a motor situated inside the base structure.

FIG. 4. Motor output shaft spinning the disc on the base structure, with four cavity grooves on the disc.

FIG. 5. Plant pot attached on top of the base structure with the pot's legs inserted into the cavity grooves of the disc.

### DETAILED DESCRIPTION OF THE INVENTION

The present invention comprises a plant pot with a mechanism that allows the pot to automatically rotate based on a preset rotational speed.

The invention will now be described by reference to the Figures.

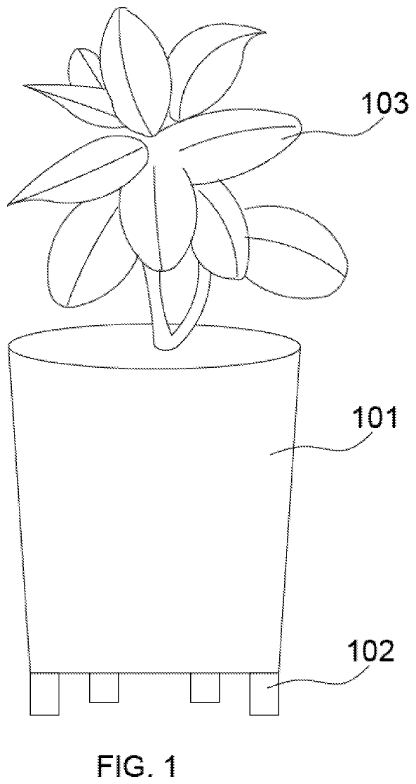

FIG. 1 shows a plant pot with four legs. The pot 101 can be of any diameter and depth. The four legs 102 reside at the bottom of the plant pot. The plant 103 is situated inside the pot.

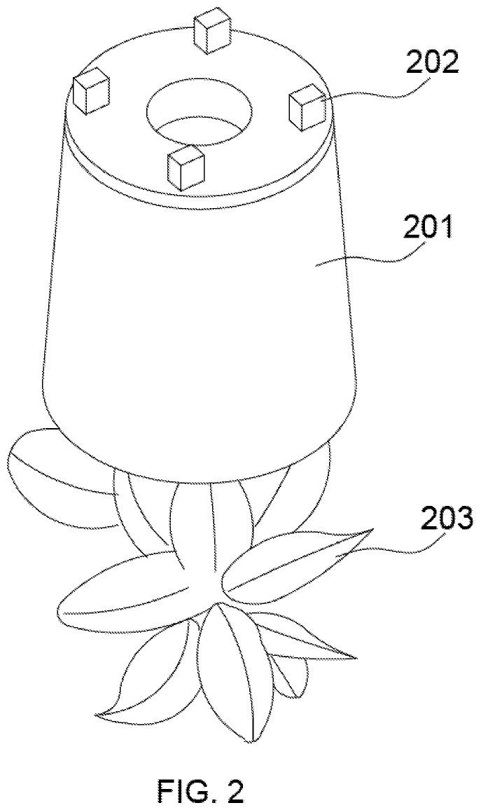

FIG. 2 shows a view from the bottom of the plant pot 201 with four legs 202 and the plant 203.

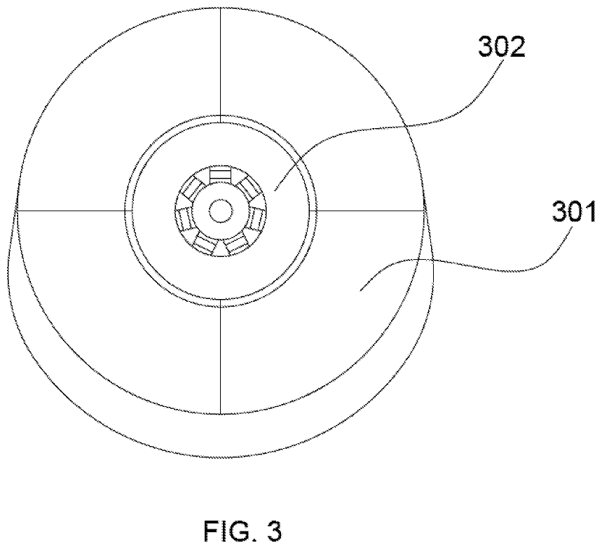

FIG. 3 shows the base structure. The base structure 301 supports the plant pot. A motor output shaft 302 is situated inside the base structure.

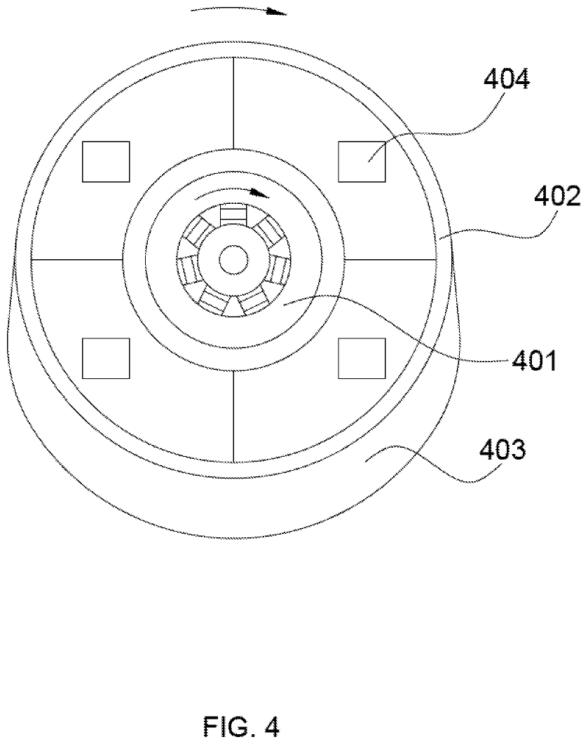

FIG. 4 shows the motor output shaft spinning the disc. The motor output shaft 401 spins the disc 402 situated above the base structure 403. The disc houses four cavity grooves 404.

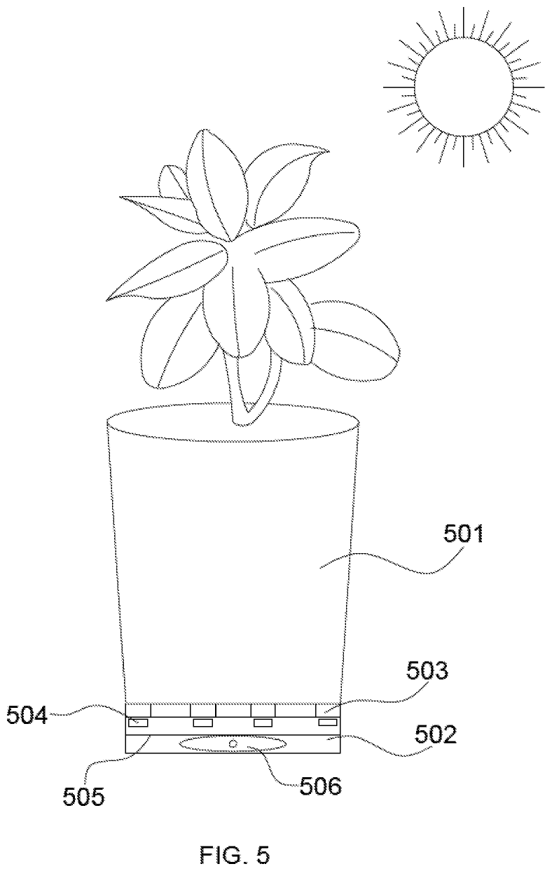

FIG. 5 shows the plant pot 501 attached on top of the base structure 502, with the pot's legs 503 inserted into the cavity grooves 504 of the disc 505. As the pot rotates, the legs inserted into cavity grooves help to keep the pot stable as it rotates around. The motor 506 resides inside the base structure.

What is claimed is:

1. An apparatus, comprising a pot suitable to hold a plant; a rotatable disc underneath said pot; a base structure supporting said pot and disc; and a motor that causes said disc and pot to rotate at a predetermined, adjustable speed on top of the base structure.
